(19) United States
(12) Patent Application Publication
(10) Pub. No.: US 2016/0299978 A1
(43) Pub. Date: Oct. 13, 2016

(54) DEVICE DEPENDENT SEARCH EXPERIENCE

(71) Applicant: Google Inc., Mountain View, CA (US)

(72) Inventor: Unni Krishnan Narayanan, Sunnyvale, CA (US)

(21) Appl. No.: 14/685,044

(22) Filed: Apr. 13, 2015

(51) Int. Cl. G06F 17/30

(52) U.S. Cl. CPC G06F 17/30867; G06F 17/3053; G06F 17/30551; G06F 17/3087

(57) ABSTRACT

A computing system is described that includes at least one processor and at least one module operable by the at least one processor to receive, from a computing device, an indication of a search query, associate a device type with the computing device, and infer, based at least in part on the device type, user intention in conducting a search of the search query. The at least one module is further operable by the at least one processor to modify, based on the user intention, the search query, after modifying the search query, execute, a search of the search query, and output, for transmission to the computing device, renderable content based on information returned from the search.

### BACKGROUND

A search query may have a different meaning depending on the type of device from which the query originates. For example, a user may interact with a non-wearable, mobile device to conduct a search of a name of a business establishment that the user knows to be near a current location with the intention of obtaining an online review or other general information about the business establishment. In contrast, the user may cause a wearable device to execute the same search for the name of the business establishment that the user knows to be near the current location with a goal of obtaining a walking distance or hours of operation associated with the business establishment. Unfortunately, despite potentially having different purposes for performing a search, a search of the same query may cause both the wearable and non-wearable devices to provide the same search results, no matter which type of device the query originated from.

### SUMMARY

In one example, the disclosure is directed to a method that includes receiving, by a computing system, from a computing device, an indication of a search query, associating, by the computing system, a device type with the computing device, and inferring, by the computing system, based at least in part on the device type, user intention in conducting a search of the search query. The method further includes modifying, by the computing system, based on the user intention, the search query, and after modifying the search query, executing, by the computing system, a search of the search query. The method further includes outputting, by the computing system, for transmission to the computing device, renderable content based on information returned from the search.

In another example, the disclosure is directed to a computing system that includes at least one processor and at least one module operable by the at least one processor to receive, from a computing device, an indication of a search query, associate a device type with the computing device, and infer, based at least in part on the device type, user intention in conducting a search of the search query. The at least one module is further operable by the at least one processor to modify, based on the user intention, the search query, after modifying the search query, execute, a search of the search query, and output, for transmission to the computing device, renderable content based on information returned from the search.

In another example, the disclosure is directed to a computer-readable storage medium including instructions that, when executed, configure one or more processors of a computing system to receive, from a computing device, an indication of a search query, associate a device type with the computing device, infer, based at least in part on the device type, user intention in conducting a search of the search query. The instructions, when executed, further configure the one or more processors of the computing system to execute, a search of the search query, and modify, based on the user intention, information returned from the search. The instructions, when executed, further configure the one or more processors of the computing system to after modifying the information returned from the search, output, for transmission to the computing device, renderable content based on the modified information returned from the search.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system for modifying search queries and outputting renderable content based on information returned from searches of the modified search queries, in accordance with one or more aspects of the present disclosure.

FIG. 2 is a block diagram illustrating an example computing system configured to modify a search query and output renderable content based on information returned from a search of the modified search query, in accordance with one or more aspects of the present disclosure.

FIG. 3 is a block diagram illustrating an example computing device that outputs graphical content for display at a remote device, in accordance with one or more techniques of the present disclosure.

FIGS. 4A-4D are conceptual diagrams illustrating example graphical user interfaces presented by example computing devices that are configured to receive renderable content based on information that is returned from a search of a modified search query, in accordance with one or more aspects of the present disclosure.

FIG. 5 is a flowchart illustrating example operations performed by an example computing system configured to modify a search query and output renderable content based on information returned from a search of the modified search query, in accordance with one or more aspects of the present disclosure.

### DETAILED DESCRIPTION

In general, techniques of this disclosure may enable a computing system to infer user intention in conducting a search of a search query based on the type of device from which the query originated and/or based on the type of device for which the search results are intended. The computing system may automatically modify the query (e.g., before conducting a search of the search query) based on the inferred intention so as to improve the likelihood that a search of the query produces information that better addresses what a user is searching for. For example, the computing system may append one or more additional search terms to a query so as to focus the search based on the intention and produce information from the search that typical users of that type of device often search for. In some examples, the information may be further tailored according to specific, individual preferences, interests, or goals.

In some examples, the computing system may process information returned from a search based on the type of device from which the query originated and convey the processed information in a unique way that is tailored specifically for that type of device. For example, the computing system may configure a non-wearable, mobile computing device (e.g., a mobile telephone) to display a search result as a static graphic and/or text, whereas the computing system may instead configure a wearable computing device (e.g., a watch) to display the same search result as an interactive graphical element that not only conveys the search result, but also promotes user interaction with a specific feature of the wearable device.

Throughout the disclosure, examples are described where a computing device and/or a computing system analyzes information (e.g., context, locations, speeds, intention, etc.) associated with a computing device and a user of a computing device, only if the computing device receives permission from the user of the computing device to analyze the information. For example, in situations discussed below, before a computing device or computing system can collect or may make use of information associated with a user, the user may be provided with an opportunity to provide input to control whether programs or features of the computing device and/or computing system can collect and make use of user information (e.g., information about a user's current location, current speed, etc.), or to dictate whether and/or how to the device and/or system may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and computing system.

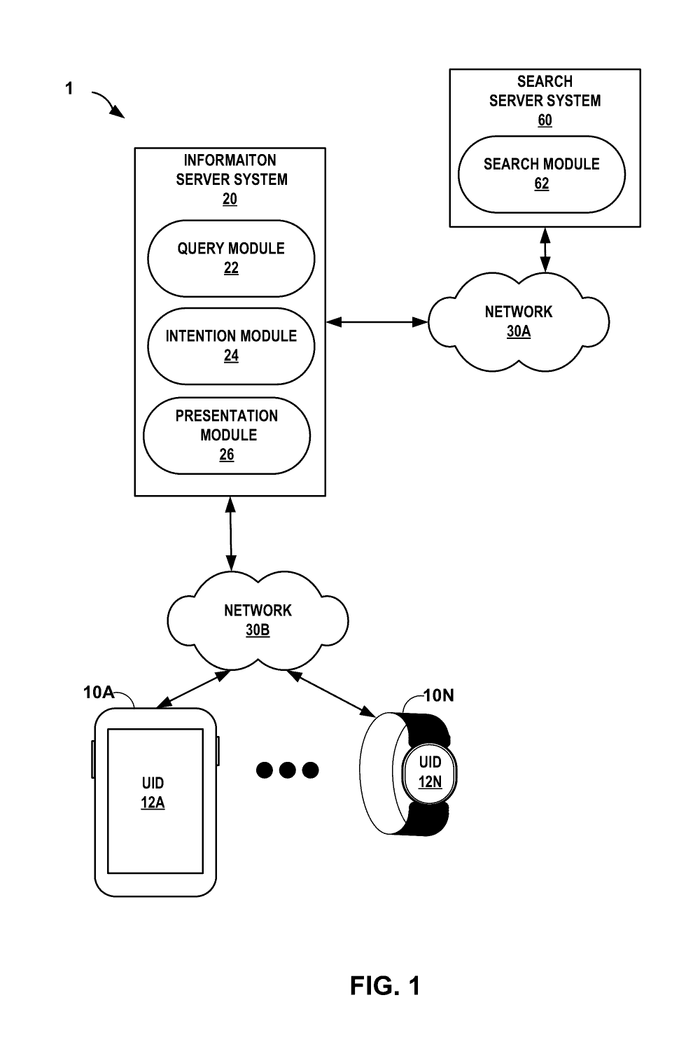

FIG. 1 is a conceptual diagram illustrating system 1 as an example system for modifying search queries and outputting renderable content based on information returned from searches of the modified search queries, in accordance with one or more aspects of the present disclosure. System 1 includes information server system (“ISS”) 20, search server system (“SSS”) 60, and computing devices 10A-10N (collectively, “computing devices 10”). ISS 20 is in communication with search system 60 over network 30A and ISS 20 is in further communication with devices 10A and 10N over network 30B.

Networks 30A and 30B (collectively “networks 30”) represents any public or private communications networks, for instance, cellular, Wi-Fi, and/or other types of networks for transmitting data between computing systems, servers, and computing devices. Networks 30 may include respective network hubs, network switches, network routers, or any other network equipment, that are operatively inter-coupled thereby providing for the exchange of information between computing devices 10 and ISS 20 and ISS 20 and SSS 60.

Computing devices 10 and ISS 20 may send and receive data across network 30B using any suitable communication techniques. Likewise, ISS 20 and SSS 60 may send and receive data across network 30B using any suitable communication techniques. In some examples, networks 30A and 30B represent a single network. For the sake of brevity and ease of description, networks 30A and 30B are described below as two separate networks representing a first communication channel between ISS 20 and SSS 60 and a second, separate, communication channel between ISS 20 and computing devices 10.

Computing devices 10A may be operatively coupled to network 30B using a first network link, and computing devices 10N may be operatively coupled to network 30B using a different network link. ISS 20 may be operatively coupled to network 30A by a first network link and SSS 60 may be operatively coupled to network 30A by a different network link. The links coupling computing devices 10, server system 20, and server system 60 to networks 30 may be Ethernet, ATM or other type of network connection, and such connections may be wireless and/or wired connections.

In the example of FIG. 1, computing devices 10A (also referred to herein as “mobile device 10A”) is a non-wearable mobile device, such as a mobile phone, a tablet computer, a laptop computer, or any other type of mobile computing device that is not configured to be worn a user's body. Computing devices 10N (also referred to herein as “wearable device 1 ON”) is a wearable computing device such as a computerized watch, computerized eyewear, computerized gloves, or any other computing device configured to be worn on user's body. However, in other examples, computing devices 10 may be any combination of tablet computers, mobile phones, personal digital assistants (PDA), laptop computers, gaming systems, media players, e-book readers, television platforms, automobile navigation systems, or any other types of mobile and/or wearable computing devices from which a user may input a search query and in response to the input, receive search results from a search performed on the search query.

As shown in FIG. 1, computing devices 10 each include respective user interface devices (UID) 12A-12N (collectively, “UIDs 12”). UIDs 12 of computing devices 10 may function as respective input and/or output devices for computing devices 10. UIDs 12 may be implemented using various technologies. For instance, UIDs 12 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. In addition, UIDs 12 may include microphone technologies, infrared sensor technologies, or other input device technology for use in receiving user input.

UIDs 12 may function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing devices 10. In addition, UIDs 12 may include speaker technologies, haptic feedback technologies, or other output device technology for use in outputting information to a user.

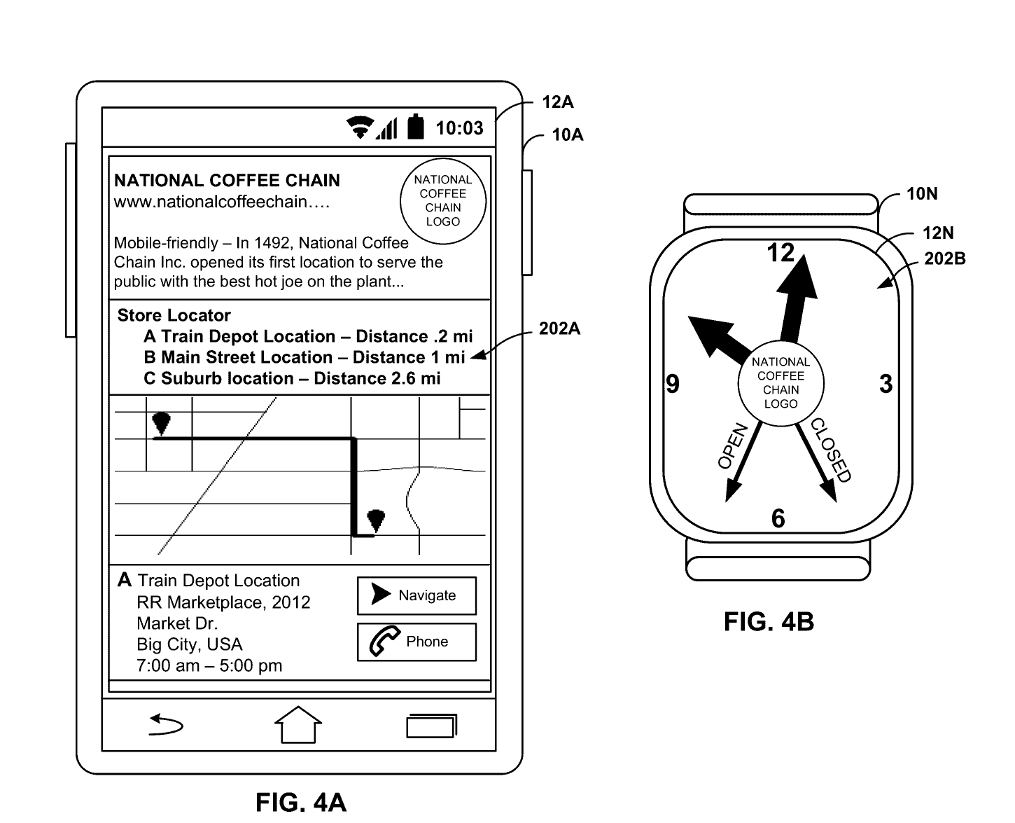

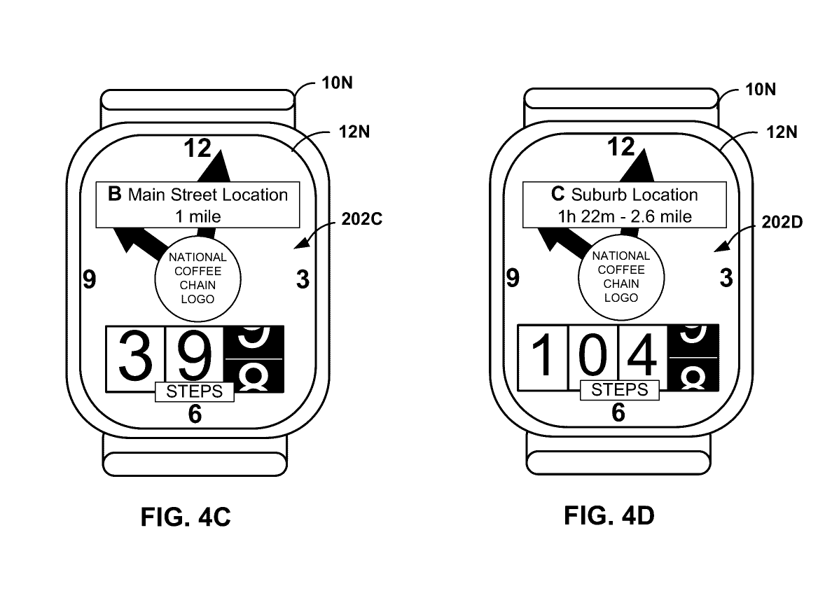

UIDs 12 may each include respective presence-sensitive displays that may receive tactile input from a user of respective computing devices 10. UIDs 12 may receive indications of tactile input by detecting one or more gestures from a user (e.g., the user touching or pointing to one or more locations of UIDs 12 with a finger or a stylus pen). UIDs 12 may present output to a user, for instance at respective presence-sensitive displays. UIDs 12 may present the output as respective graphical user interfaces (e.g., user interfaces 102A-102D of FIGS. 4A-4D), which may be associated with functionality provided by computing devices 10. For example, UIDs 12 may present various user interfaces related to search functions or other features of computing platforms, operating systems, applications, and/or services executing at or accessible from computing devices 10 (e.g., electronic message applications, Internet browser applications, mobile or desktop operating systems, etc.). A user may interact with a user interface presented at one of UIDs 12 to cause the respective one of computing devices 10 to perform operations relating to functions, such as executing a search.

In operation, users of computing devices 10 may provide inputs to UIDs 12 which are indicative of search queries for causing computing devices 10 to execute respective searches for information (e.g., on the Internet, within a database, or other information repository) of the inputted search queries. For example, a user of computing devices 10N may provide voice input to UID 12N to cause wearable device 10N to conduct a voice search for information relating to the voice input. UID 12N may receive the voice input at UID 12N and responsive to outputting (e.g., via network 30A to ISS 20) information (e.g., data) based on the voice input, wearable device 10N may receive (e.g., via network 30A from ISS 20) renderable content based on information returned from the search.

ISS 20 and SSS 60 represent any suitable remote computing systems, such as one or more desktop computers, laptop computers, mainframes, servers, cloud computing systems, etc. capable of receiving information (e.g., an indication of a search query or other types of data) and sending information (e.g., an indication of a modified search query, renderable content based on information returned from the search, or other types of data) via networks 30. In some examples, the features and functionality of SSS 60 reside locally as part of ISS 20. In other examples, as shown in FIG. 1, SSS 60 and ISS 20 are two standalone computing systems operably coupled via network 30A.

In some examples, ISS 20 represents a web server for providing access to a search service hosted by SSS 60. One or more of computing devices 10 may access the search service hosted by SSS 60 by transmitting and/or receiving search related data via network 30A, to and from ISS 20. In some examples, ISS 20 and SSS 60 represent cloud computing systems that provides search services through networks 30 to one or more of computing devices 10 that access the search services via access to the cloud provided by ISS 20 and SSS 60.

In the example of FIG. 1, ISS 20 includes query module 22, intention module 24, and presentation module 26. SSS 60 includes search module 62. Modules 22-26 and 62 may perform operations described herein using software, hardware, firmware, or a mixture of hardware, software, and firmware residing in and/or executing at ISS 20 and SSS 60. ISS 20 may execute modules 22-26, and SSS 60 may execute module 62, with multiple processors or multiple devices. ISS 20 may execute modules 22-26, and SSS 60 may execute module 62, as one or more virtual machines executing on underlying hardware. Modules 22-26 and 62 may execute as one or more services of an operating system or computing platforms associated with ISS 20 and SSS 60. Modules 22-26 and 62 may execute as one or more executable programs at an application layer of a computing platform associated with ISS 20 and SSS 60.

In operation, search module 62 of SSS 60 performs search operations associated with identifying information, related to a search query that is stored locally at search server system 60 and/or across network 30A at other server systems (e.g., on the Internet). Search module 62 of SSS 60 may receive an indication of a search query or an indication of a modified search query and a request to execute a search from information server system 20. Based on the search query and search request, search module 62 may execute a search for information related to the search. After executing a search based on a search query, search module 62 may output the information returned from the search.

For example, search module 62 may receive a text string, audio data, or other information as a search query that includes one or more words to be searched. Search module 62 may conduct an Internet search based on the search query to identify one or more data files, webpages, or other types of data accessible on the Internet that include information related to the search query. After executing a search, search module 62 may produce information returned from the search (e.g., a list of one or more uniform resource locators [URLs], or other addresses identifying the location of a file on the Internet that consists of the protocol, the computer on which the file is located, and the file's location on that computer). In some examples, search module 62 may produce a ranking of the different types of information returned from the search so as to identify which pieces of information are more closely related to the search query. Search module 62 may output, via network 30A, to ISS 20, the information returned from a search and/or a ranking

ISS 20 provides computing devices 10 with a conduit through which computing devices 10 may execute searches for information related to search queries. In this way, ISS 20 presents a search experience which consists of a user interface and ranking criteria to deliver a compelling end user experience depending on whether a user conducts a business/establishment query from a wearable device or a mobile device.

ISS 20 may infer user intention in conducting a search of a search query based on the type of device from which the query originated. ISS 20 may automatically modify a query based on an inferred intention so as to improve a likelihood that a search of a query produces information that better addresses what a user is searching for. After modifying a query based on inferred intention and executing a search of the query, ISS 20 may output (for transmission across network 30B to computing devices 10) renderable content based on information returned from the search.

Query module 22 provides computing devices 10 an interface through which computing devices 10 may access the search service provided by search module 62 and search server system 60. For example query module 22 may provide an application user interface (API) from which a computing platform or application executing at computing devices 10 can provide an indication of a search query (e.g., text, graphics, or audio data) and in return, receive results of the search query (e.g., as renderable content for presentation at UIDs 12).

Query module 22 may request information from intention module 24 relating to the “intention of a user” in conducting a search of a search query. Based on the inferred intention received from intention module 24, query module 22 may modify a search query received from computing devices 10 before calling on search server system 60 to execute a search of the search query. For example query module 22 may insert, remove, or otherwise modify the text, graphic, or audio data received from computing devices 10, based on the intention of the user, so that a search of the query more likely produces useful information that a user is searching for. Query module 22 may access a database of additional query terms that can be added to a query to improve a search, depending on the intention of the user in performing the search. Query module 22 may look up an intention at the data base and add one or more additional parameters stored in the data base to a search query (e.g., a current location, a time parameter, a distance parameter, or other such parameter) before sending the modified search query to SSS 60.

Presentation module 26 may generate renderable content based on information returned from a search that query module 22 may output, via network 30B to computing devices 10, for presentation at UIDs 12. Presentation module 26 may generate different types of renderable content, including different types of information, depending on inferred user intention in conducting a search and the type of device 10 from which the query was received and the renderable content is being delivered.

For example, presentation module 26 may receive information from intention module 24 about the inferred user intention in conducting a search. Presentation module 26 may parse information returned by SSS 60 following execution of a search to identify the types of information that is more likely to satisfy the user intention. For instance, the user intention may be time, distance, or product purchase price and location information and presentation module 26 may identify a time, distance, or product purchase price and location information from the information returned by SSS 60 after execution of the search. Whereas, the user intention may be general information, online review information, or other information not related to a time, a distance, or a purchase price and location associated with the search query. Presentation module 26 may identify general information, online review information, or other information not related to a time, a distance, or a purchase price and location associated with the search query from the information returned by SSS 60 after execution of the search.

Presentation module 26 may package the search information, that presentation module 26 deems to be most related to the user intention, in a form that is more suitable for the type of device 10 from which the original search query originated from. In other words, rather than generate the same renderable content for two different devices 10 that request a search of the same query, presentation module 26 may produce customized renderable content for each one of devices 10, so that each one of devices 10 provides information, in the formats that is uniquely suited to the type of device and the inferred user intention from which the search query originated from.

Intention module 24 may perform functions for inferring the intention of a user of computing devices 10 in conducting a search of a search query received by query module 22. Intention module 24 may determine the user intention based on the device type from which the search query originates, contextual information, and/or the search query itself. In some examples, if results of the search are to be presented at a different device than the device from which the query originates from, intention module 24 may determine the user intention based on the end point device, that is, the one of devices 10 at which the results of the search are to be presented.

Intention module 24 of ISS 20 may receive an indication from query module 22 of the type of device that is associated with a search query. The device types may vary between: mobile type device, wearable type device, telephone type device, laptop type device, non-mobile type device, non-wearable type device, or other types of devices. Intention module 24 may further receive “contextual information” from each of computing devices 10. Intention module 24 may also receive an indication of the search query.

Based on the device type, contextual information, and/or the search query itself, intention module 24 determine or otherwise infer a user intention in conducting a search of a query. Intention module 24 may respond to queries (e.g., from presentation module 26 and query module 22) requesting information indicating the intention of the user in conducting a search of a search query.

Examples of inferred intentions of users in conducting searches include: finding information related to a time, a distance, or a purchase price associated with the search query. For example, operating hours of a business, commercial, or governmental location, distance to a closest business, commercial, governmental, or residential location, location of a retail establishment to purchase a product or price at a particular establishment. Additional examples of inferred intentions of users in conducting searches include: finding contact information, review information, or other information not related to a time, a distance, or a purchase price associated with the search query. For example, telephone, e-mail, or web address information of a business, commercial, or governmental location, distance to a multiple business, commercial, governmental, or residential locations, locations of all the different retail establishments to purchase a product or prices at all the various locations.

Intention module 24 may infer the user intention in conducting a search of a search query by inputting the device type, contextual information, and/or terms of a search query, into a rules based algorithm or a machine learning system to determine the most likely intention that a user has in conducting a search of a search query. For instance, when searching for a name of a business establishment from a wearable device, a machine learning system may infer that the intention of the user is to obtain information related to hours of operation associated with the business establishment and/or a distance to the business establishment. Instead, when searching for the same name of the business establishment from a mobile device other than a wearable device, the machine learning system may infer that the intention of the user is to obtain information related to reviews or other general information associated with the business establishment besides the hours of operation or distance.

Said differently, the rules based algorithm or the machine learning system of intention module 24 may be based on various observations about user behavior and interests in information when using different types of devices 10. For example, if a user queries a location (e.g., the location of such as a coffee house) from a watch, there is a high likelihood that the user is interested in the hours the coffee house is open. This first observation is based upon two insights: first, that watches, are intrinsically designed for time keeping and appointment making, and other time related practices, and secondly, watches are typically designed for “glance-able” experiences. Therefore, the rules based algorithm or the machine learning system of intention module 24 may output intention of a user based on a presumption that if a user would more likely want to receive anything but the hours of operation of the establishment, then he or she would not have executed the query on a watch. In other words, based on user habits, time of day, prior searches and associated actions, etc., intention module 24 may conclude the user intention for performing a search while using a watch is to determine a time of day.

As another example, if a user queries a location (e.g., the location of such as a coffee house) from a watch, there is a high likelihood that the user uses the watch for fitness purposes (e.g., step counts, exercise goals, etc.), and there is a high likelihood the user would find value in seeing customized distance information about the location (e.g., to meet a fitness goal). In addition, the user may want to be provided with a control for launching a fitness app or fitness data UI from the watch as the user begins the journey to the destination. This first observation is based upon two insights: first, that watches, are used for fitness purposes (like fitness bands) (in addition to time keeping) than mobile devices, and are often linked to fitness application, and second that watches, are designed for “glance-able” experiences. Therefore, the rules based algorithm or the machine learning system of intention module 24 may output intention of a user based on a presumption that if a user would more likely want to receive anything but the customized distance information about the establishment, then he or she would not have executed the query on a fitness watch. In other words, based on the same set of observations that intention module 24 used to conclude the user intention in searching for a location was a time of day, intention module 24 may instead conclude that the user intention for the location is to determine fitness aspects for the search, and launch or initiate a fitness app. After executing the search, the watch may present the user with a control for launching a fitness app or fitness data UI from the watch as the user begins the journey to the location.

In this way, the techniques of this disclosure may provide computing devices with tailored information that is more likely to be of interest to a user of either a mobile device or a wearable device when conducting a search of a search query. By automatically inferring user intention in conducting a search of a search query, system 1 may reduce a quantity of inputs that a user needs to provide at computing devices in order to obtain the precise information he or she is searching for. By reducing the quantity of inputs and interaction time, the techniques of this disclosure computing device to perform fewer operations for conducting a search and may conserve electrical power and battery life.

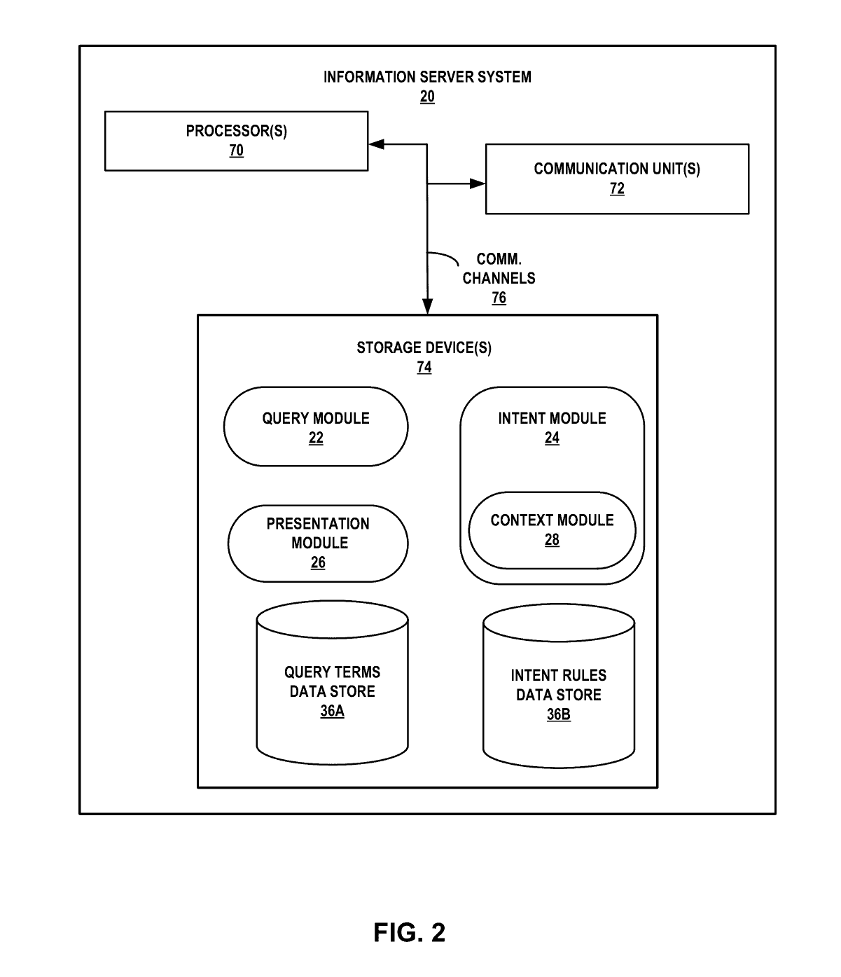

FIG. 2 is a block diagram illustrating ISS 20 in greater detail as an example computing system configured to modify a search query and output renderable content based on information returned from a search of the modified search query, in accordance with one or more aspects of the present disclosure. FIG. 2 is described below in the context of system 1 of FIG. 1. FIG. 2 illustrates only one particular example of ISS 20, and many other examples of ISS 20 may be used in other instances and may include a subset of the components included in example ISS 20 or may include additional components not shown in FIG. 2.

ISS 20 provides computing devices 10 with a conduit through which a computing device, such as wearable device 10N or mobile computing devices 10A, may execute searches for information related to search queries. As shown in the example of FIG. 2, ISS 20 includes one or more processors 70, one or more communication units 72, and one or more storage devices 74. Storage devices 74 of ISS 20 include query module 22, intention module 24, and presentation module 26. Within intention module 24, storage devices 74 includes context module 28. Storage devices 74 of ISS 20 further include query terms data store 36A, and intention rules data store 36B (collectively, “data stores 36”). Communication channels 76 may interconnect each of the components 70, 72, and 74 for inter-component communications (physically, communicatively, and/or operatively). In some examples, communication channels 76 may include a system bus, a network connection, an inter-process communication data structure, or any other method for communicating data.

One or more communication units 72 of ISS 20 may communicate with external computing devices, such as computing devices 10, by transmitting and/or receiving network signals on one or more networks, such as networks 30. For example, ISS 20 may use communication unit 72 to transmit and/or receive radio signals across network 30B to exchange information with computing devices 10. Examples of communication unit 72 include a network interface card (e.g. such as an Ethernet card), an optical transceiver, a radio frequency transceiver, a GPS receiver, or any other type of device that can send and/or receive information. Other examples of communication units 72 may include short wave radios, cellular data radios, wireless Ethernet network radios, as well as universal serial bus (USB) controllers.

One or more storage devices 74 within ISS 20 may store information for processing during operation of ISS 20 (e.g., ISS 20 may store data accessed by modules 22, 24, and 26 during execution at ISS 20). In some examples, storage devices 74 are a temporary memory, meaning that a primary purpose of storage devices 74 is not long-term storage. Storage devices 74 on ISS 20 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 74, in some examples, also include one or more computer-readable storage media. Storage devices 74 may be configured to store larger amounts of information than volatile memory. Storage devices 74 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 74 may store program instructions and/or data associated with modules 62, 64, and 66.

One or more processors 70 may implement functionality and/or execute instructions within ISS 20. For example, processors 70 on ISS 20 may receive and execute instructions stored by storage devices 74 that execute the functionality of modules 22, 24, and 26. These instructions executed by processors 70 may cause ISS 20 to store information, within storage devices 74 during program execution. Processors 70 may execute instructions of modules 22, 24, and 26 to provide renderable content for presentation by one or more computing devices (e.g., computing devices 10 of FIG. 1). That is, modules 22, 24, and 26 may be operable by processors 70 to perform various actions or functions of ISS 20.

Data stores 36 represent any suitable storage medium for storing information related to search queries (e.g., search terms, synonyms, related search terms, etc.) and rules (e.g., of a machine learning system) for discerning intention of a user in conducting a search of a search query. The information stored at data stores 36 may be searchable and/or categorized such that modules 22-26 may provide an input requesting information from data stores 36 and in response to the input, receive information stored at data stores 36.

Query terms data store 36A may include additional query terms that can be added to a query to improve a search (e.g., depending on the intention of the user in performing the search). Modules 22-26 may look up an intention and/or search query within data store 36A, and retrieve, based on the lookup, one or more additional search terms or “parameters” stored in the data base that can be added to a search query.

For example, query terms data store 36A may include search terms related to a location or business, such as a type of location or business, similar locations or businesses, products sold or services provided at the location or by the business, or other information related to the location or business such as time parameters and distance parameters associated with the location or business. In some examples, query terms data store 36A may store search terms that are terms that are generally related to businesses or commercial enterprises, such as the terms “hours of operation”, “admission charge”, “closest”, “furthest”, or other terms or information that query module 22 may add to a search query that includes a name of a business or location, so as to narrow a search of the search query based on user intention. In some examples, query terms data store 36A may store search terms that are terms that are user specific, and related to businesses or commercial enterprises. In other words, the search terms may be tied to specific or personalized fitness goals, search histories, and/or other interests of a user, such as a term specifying a minimum or maximum quantity of steps that a user wants to take, a term specifying a certain distance that the user is trying to cover in a day, a term specifying “cost”, “flavor”, or other attribute of a specific product he or she frequently buys or recommends, or other terms or information that are tailored to a user that query module 22 may add to a search query that includes a name of a business or location, so as to narrow a search of the search query based on user intention. In any case, query module 22 may provide an indication of user intention and a search query to query terms data store 36A and in response, receive one or more search terms to append to the search query prior to causing SSS 60 to conduct the search.

In some examples, intention rules data store 36B may store information specifying one or more rules of a machine learning algorithm or other prediction system used by intention module 24 in determining or otherwise inferring the intention of a user in conducting a search of a search query. For example, intention module 24 may provide as inputs to intention rules data store 36B information pertaining to a search query, a device type identifier, and/or contextual information received from computing devices 10, and receive as output from data store 36B, one or more indications of the user intention. Examples of a user intention include: an intention to search for time information, distance information, product information, cost information, general information, online reviews, contact information, or other information, e.g., specific to a location or business.

Context module 28 may perform operations for determining a context associated with a user of computing devices 10. Context module 28 may process and analyze contextual information (e.g., respective locations, direction, speed, velocity, orientation, etc.) associated with computing devices 10, and based on the contextual information, define a context specifying the state or physical operating environment of computing devices 10. In other words, context module 28 may process contextual information received from computing devices 10 and use the contextual information to generate a context of the user of computing devices 10 that specifies one or more characteristics associated with the user of computing devices 10 and his or her physical surroundings at a particular time (e.g., location, name, address, and/or type of place, building, etc., weather conditions, traffic conditions, calendar information, meeting information, event information, etc.). For example, context module 28 may determine a physical location associated with computing device 10N and update the physical locations as context module 28 detects respective movement, if any, associated with computing device 10N over time.

In some examples, context module 28 may determine a context of a user of computing devices 10 based on communication information received by computing devices 10. For example, ISS 20 may have access to communications or other profile information associated with the user of computing devices 10 (e.g., stored calendars, phone books, message accounts, e-mail accounts, social media network accounts, and the like) and analyze the communication information for information pertaining to a user's current location. For example, context module 28 may analyze an electronic calendar associated with the user of computing devices 10 that indicates when the user will be home, at work, at a friend's house, etc. and infer, based on the calendar information, that the user of computing devices 10 is at the location specified by the calendar information at the time specified by the calendar information.

Context module 28 may maintain a location history associated with the user of computing devices 10. For example, context module 28 may periodically update a location of computing devices 10 and store the location along with a day and time information in a database (e.g., a data store) and share the location information with recommendation module 66 to predict, infer, or confirm when a user of computing devices 10 is likely at a content-viewing location at a future time. Context module 28 may maintain a location history associated with computing devices 10 and correlate the location histories to determine when devices 10 will be or are at a particular location.

Context module 28 may determine, based on the contextual information associated with computing devices 10, a type of device or device type associated with each of devices 10. For example, context module 28 may obtain various types of metadata, including device identifiers, from query module 22 when query module 22 receives information, including a search query, from devices 10. Context module 28 may classify each of devices 10 according to a device type or type of device, based on the device identifier. For example, when query module 22 receives a search query, query module 22 may also receive a telephone number, e-mail address, MAC address, IP address, or other identifying information, from which, context module 28 can discern which type of device (e.g., a mobile device or a wearable device) that query module 22 received the query. Intention module 24 may rely on the device type identified by context module 22 to determine the intention of a user in conducting a search of the search query.

As used throughout the disclosure, the term “contextual information” is used to describe information that can be used by a computing system and/or computing device, such as ISS 20 and computing devices 10, to determine one or more environmental characteristics associated with computing devices and/or users of computing devices, such as past, current, and future physical locations, degrees of movement, weather conditions, traffic conditions, patterns of travel, and the like. In some examples, contextual information may include sensor information obtained by one or more sensors (e.g., gyroscopes, accelerometers, proximity sensors, etc.) of computing devices 10, radio transmission information obtained from one or more communication units and/or radios (e.g., global positioning system (GPS), cellular, Wi-Fi, etc.) of computing devices 10, information obtained by one or more input devices (e.g., cameras, microphones, keyboards, touchpads, mice, etc.) of computing devices 10, and network/device identifier information (e.g., a network name, a device internet protocol address, etc.).

In operation, ISS 20 provides a scheme for causing computing devices 10 to present a compelling based search experience for search queries (e.g., location or business establishment queries) that are being conducted from different types of devices (e.g., including different types of wearable and mobile devices). As one example, a user of wearable device 10N may input, at UID 12N, a search query about a location or a business establishment such as a national chain of coffee house. Query module 22 may receive the search query and determine that the search query is a query representing the name or type of a business or establishment.

As described above, intention module 24 may rely on context module 28 to determine the type of device from which the search query originated from. In this case, intention module 24 may determine the device type to be a wearable device. Intention module 24 may also rely on context module 28 to determine a context of the device from which the search query originated from. Intention module 24 may provide the device type and/or context determined by context module 28, along with the search query received from query module 22, as inputs into a machine learning algorithm at intention rules data store 36B. In response, intention module 24 may receive, as output from the machine learning algorithm at intention rules data store 36B, an indication of the intention of the user in conducting a search of the search query. For instance, intention module 24 may infer that the user intention is to identify operating hours of the coffee house. Intention module 24 may share the indication of the intention of the user with query module 22 for modifying the search query based on the intention.

In some examples, intention module 24 may infer a first intention in conducting a search of the search query for a first device type and may instead infer a second intention in conducting a search of the search query, different from the first intention, for a second device type that is different from the first device type. In other words, based on the type of device determined by context module 28, intention module 24 may infer different user intentions in conducting searches of the same search query. For example, if intention module 24 determines that the first device type is a wearable computing device and the second device type is a mobile telephone, then intention module 24 may determine that the first intention in conducting a search of the search query is related to a time, a distance, or a purchase price associated with the search query and the second intention in conducting a search of the search query is related to contact information, review information, or other information not related to a time, a distance, or a purchase price associated with the search query. In this way, a user may be provided with search information based on a search query that is more likely what the user was intending to search for, given the type of device from which he or she is conducting the search.

Query module 22 may modify, based on the user intention, the search query. For example, query module 22 may rely on query terms data store 36A to identify one or more additional search parameters for focusing a search of the search query towards a specific result that is based on the user intention inferred by intention module 24. Query module 22 may provide the search query and user intention to query terms data store 36A and in response, receive one or more additional search terms. Query module 22 may add the one or more additional search parameters to the search query before calling on SSS 60 to execute a search of the search query. For example, query module 22 may add the term “operating hours” to the search query to configure SSS 60 to identify the operating hours of the coffee house.

In some examples, query module 22 may rely, like intention module 24, on the device type from which the query originated or from which the search results are intended to be delivered to (i.e., the end point device), to determine a further modification to the search query. For example, query module 22 may determine, based at least in part on the device type, a feature of the respective one of computing devices 10 and modify the query, before execution of the search, based on the feature of that computing device. For instance, when a search query is received from wearable device 10N, query module 22 may determine the device type to be a wearable device type and the primary feature to be at least one of fitness tracking, tracking a time of day, or tracking distance traveled. Query module 22 may append terms related to fitness tracking (e.g., “calories”), tracking a time of day (e.g., “hours of operation”, or tracking distance traveled (e.g., “steps”) to the search query in response to determining the device type to be wearable.

Or, when a search query is received from mobile device 10A, query module 22 may determine the device type to be a mobile device type (i.e., not a wearable device) and the primary feature to be at least one of communicating (e.g., telephone, e-mail, text messaging, etc.), reading websites, completing complex tasks, etc. Query module 22 may append terms related to communicating (e.g., “contact information”), reading websites (e.g., “homepage” and the like in response to determining the device type to be mobile and not wearable.

In some examples, query module 22 may modify a search query based on the inferred user intention by, adding a current location (e.g., a coordinate location, a physical address, etc.) of the computing device from which the search query was received or for which the search results are intended, to the search query. In some examples, query module 22 may modify a search query based on the inferred user intention by, adding a time parameter to the search query (e.g., “hours of operation”, “opening”, “closing”, etc.). In some examples, query module 22 may modify a search query based on the inferred user intention by, adding a distance parameter to the search query (e.g., “nearest”, “closest”, etc.).

After modifying the search query, query module 22 may transmit, via communication units 72 and across network 30A, the modified search query to SSS 60 for executing a search of the search query. Query module 22 may receive, from SSS 60, information returned from the search. For example, query module 22 may receive information from SSS 60 indicating that the coffee house which was searched, is open between the hours of 7:00 AM to 3:00 PM.

Query module 22 may provide the information returned from the search to presentation module 26 for further processing and incorporation into renderable content for presentation at the one of computing devices 10 for which the returned information is intended (e.g., the endpoint device). For example query module 22 may output data to presentation module 26 indicative of the hours of operation associated with the coffee house, as well as a graphical logo associated with the coffee house.

Presentation module 26 may package the information returned from the search into renderable content that is specifically tailored for the device from which the query was received or for the device for which the information is intended (e.g., the endpoint device). For instance, presentation module 26 may generate renderable content of the hours of operation of a business, for display by wearable device 10N, as either an “analog” or “digital” watch overlay on the watch face, with or without the address of the business.

Presentation module 26 may package the renderable content in the form of hyper-text markup language (HTML) data. Computing device 10N may render the renderable content (e.g., a rendering engine may process the HTML data) and configure UID 12N to output the rendering of the renderable content for display (e.g., as a static or interactive image).

Presentation module 26 may further embed some user interaction into the renderable content, such that when devices 10 present the content, a user can interact with the content (e.g., by providing inputs at UIDs 12). For example, presentation module 26 may configure a watch overlay to accept input (e.g., tap input) that causes the overlay to transform into a standard list or generic HTML page of text and/or graphics of the search results or search information.

Presentation module 26 may output, for transmission to computing device 10N, the renderable content based on information returned from the search. For example, presentation module 26 may output the HTML data, for transmission to wearable device 10N, via network 30B, using communication units 72.

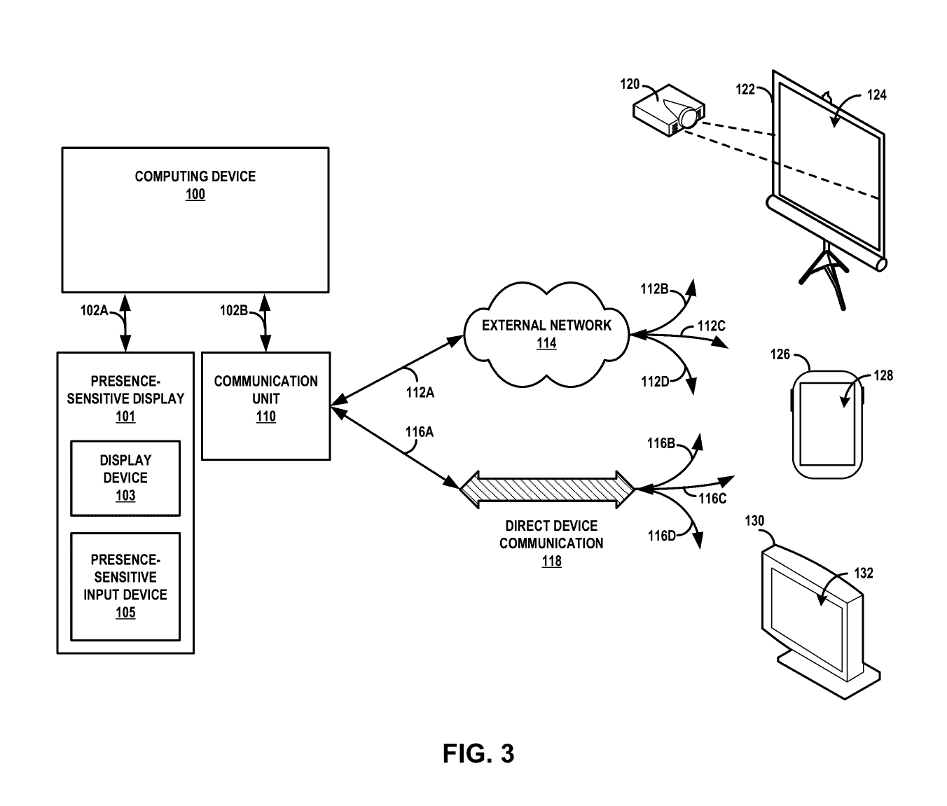

FIG. 3 is a block diagram illustrating an example computing device that outputs graphical content for display at a remote device, in accordance with one or more techniques of the present disclosure. Graphical content, generally, may include any visual information that may be output for display, such as text, images, a group of moving images, etc. The example shown in FIG. 3 includes a computing devices 100, presence-sensitive display 101, communication unit 110, projector 120, projector screen 122, mobile device 126, and visual display device 130. Although shown for purposes of example in FIG. 1 as multiple stand-alone computing devices 10, a computing device such as one of computing devices 10, and computing devices 100 may, generally, be any component or system that includes a processor or other suitable computing environment for executing software instructions and, for example, need not include a presence-sensitive display.

As shown in the example of FIG. 3, computing devices 100 may be a processor that includes functionality as described with respect to processors 70 in FIG. 2. In such examples, computing devices 100 may be operatively coupled to presence-sensitive display 101 by a communication channel 102A, which may be a system bus or other suitable connection. Computing devices 100 may also be operatively coupled to communication unit 110, further described below, by a communication channel 102B, which may also be a system bus or other suitable connection. Although shown separately as an example in FIG. 3, computing devices 100 may be operatively coupled to presence-sensitive display 101 and communication unit 110 by any number of one or more communication channels.

In other examples, such as illustrated previously by computing devices 10 in FIG. 1, a computing device may refer to a portable or mobile device such as mobile phones (including smart phones), laptop computers, or a wearable computing device such as a computerized watch, computerized eyewear, etc. In some examples, a computing device may be a desktop computers, tablet computers, smart television platforms, cameras, personal digital assistants (PDAs), servers, mainframes, etc.

Presence-sensitive display 101 may include display device 103 and presence-sensitive input device 105. Display device 103 may, for example, receive data from computing devices 100 and display the graphical content. In some examples, presence-sensitive input device 105 may determine one or more inputs (e.g., continuous gestures, multi-touch gestures, single-touch gestures, etc.) at presence-sensitive display 101 using capacitive, inductive, and/or optical recognition techniques and send indications of such input to computing devices 100 using communication channel 102A. In some examples, presence-sensitive input device 105 may be physically positioned on top of display device 103 such that, when a user positions an input unit over a graphical element displayed by display device 103, the location at which presence-sensitive input device 105 corresponds to the location of display device 103 at which the graphical element is displayed. In other examples, presence-sensitive input device 105 may be positioned physically apart from display device 103, and locations of presence-sensitive input device 105 may correspond to locations of display device 103, such that input can be made at presence-sensitive input device 105 for interacting with graphical elements displayed at corresponding locations of display device 103.

As shown in FIG. 3, computing devices 100 may also include and/or be operatively coupled with communication unit 110. Examples of communication unit 110 may include a network interface card, an Ethernet card, an optical transceiver, a radio frequency transceiver, or any other type of device that can send and receive information. Other examples of such communication units may include Bluetooth, 3G, and Wi-Fi radios, Universal Serial Bus (USB) interfaces, etc. Computing devices 100 may also include and/or be operatively coupled with one or more other devices, e.g., input devices, output devices, memory, storage devices, etc. that are not shown in FIG. 3 for purposes of brevity and illustration.

FIG. 3 also illustrates a projector 120 and projector screen 122. Other such examples of projection devices may include electronic whiteboards, holographic display devices, heads up display (HUD) and any other suitable devices for displaying graphical content. Projector 120 and projector screen 122 may include one or more communication units that enable the respective devices to communicate with computing devices 100. In some examples, the one or more communication units may enable communication between projector 120 and projector screen 122. Projector 120 may receive data from computing devices 100 that includes graphical content. Projector 120, in response to receiving the data, may project the graphical content onto projector screen 122. In some examples, projector 120 may determine one or more inputs (e.g., continuous gestures, multi-touch gestures, single-touch gestures, etc.) at projector screen 122 using optical recognition or other suitable techniques and send indications of such input using one or more communication units to computing devices 100. In such examples, projector screen 122 may be unnecessary, and projector 120 may project graphical content on any suitable medium and detect one or more user inputs using optical recognition or other such suitable techniques.

Projector screen 122, in some examples, may include a presence-sensitive display 124. Presence-sensitive display 124 may include a subset of functionality or all of the functionality of UI device 4 as described in this disclosure. In some examples, presence-sensitive display 124 may include additional functionality. Projector screen 122 (e.g., an electronic display of computing eye glasses), may receive data from computing devices 100 and display the graphical content. In some examples, presence-sensitive display 124 may determine one or more inputs (e.g., continuous gestures, multi-touch gestures, single-touch gestures, etc.) at projector screen 122 using capacitive, inductive, and/or optical recognition techniques and send indications of such input using one or more communication units to computing devices 100.

FIG. 3 also illustrates mobile device 126 and visual display device 130. Mobile device 126 and visual display device 130 may each include computing and connectivity capabilities. Examples of mobile device 126 may include e-reader devices, convertible notebook devices, hybrid slate devices, computerized watches, computerized eyeglasses, etc. Examples of visual display device 130 may include other semi-stationary devices such as televisions, computer monitors, automobile displays, etc. As shown in FIG. 3, mobile device 126 may include a presence-sensitive display 128. Visual display device 130 may include a presence-sensitive display 132. Presence-sensitive displays 128, 132 may include a subset of functionality or all of the functionality of display device 12 as described in this disclosure. In some examples, presence-sensitive displays 128, 132 may include additional functionality. In any case, presence-sensitive display 132, for example, may receive data from computing devices 100 and display the graphical content. In some examples, presence-sensitive display 132 may determine one or more inputs (e.g., continuous gestures, multi-touch gestures, single-touch gestures, etc.) at projector screen using capacitive, inductive, and/or optical recognition techniques and send indications of such input using one or more communication units to computing devices 100.

In some examples, computing devices 100 may output graphical content for display at presence-sensitive display 101 that is coupled to computing devices 100 by a system bus or other suitable communication channel. Computing devices 100 may also output graphical content for display at one or more remote devices, such as projector 120, projector screen 122, mobile device 126, and visual display device 130. For instance, computing devices 100 may execute one or more instructions to generate and/or modify graphical content in accordance with techniques of the present disclosure. Computing devices 100 may output the data that includes the graphical content to a communication unit of computing devices 100, such as communication unit 110. Communication unit 110 may send the data to one or more of the remote devices, such as projector 120, projector screen 122, mobile device 126, and/or visual display device 130. In this way, computing devices 100 may output the graphical content for display at one or more of the remote devices. In some examples, one or more of the remote devices may output the graphical content at a presence-sensitive display that is included in and/or operatively coupled to the respective remote devices.

In some examples, computing devices 100 may not output graphical content at presence-sensitive display 101 that is operatively coupled to computing devices 100. In other examples, computing devices 100 may output graphical content for display at both a presence-sensitive display 101 that is coupled to computing devices 100 by communication channel 102A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing devices 100 and output for display at presence-sensitive display 101 may be different than graphical content display output for display at one or more remote devices.

Computing devices 100 may send and receive data using any suitable communication techniques. For example, computing devices 100 may be operatively coupled to external network 114 using network link 112A. Each of the remote devices illustrated in FIG. 3 may be operatively coupled to network external network 114 by one of respective network links 112B, 112C, and 112D. External network 114 may include network hubs, network switches, network routers, etc., that are operatively inter-coupled thereby providing for the exchange of information between computing devices 100 and the remote devices illustrated in FIG. 3. In some examples, network links 112A-112D may be Ethernet, ATM or other network connections. Such connections may be wireless and/or wired connections.

In some examples, computing devices 100 may be operatively coupled to one or more of the remote devices included in FIG. 3 using direct device communication 118. Direct device communication 118 may include communications through which computing devices 100 sends and receives data directly with a remote device, using wired or wireless communication. That is, in some examples of direct device communication 118, data sent by computing devices 100 may not be forwarded by one or more additional devices before being received at the remote device, and vice-versa. Examples of direct device communication 118 may include Bluetooth, Near-Field Communication, Universal Serial Bus, Wi-Fi, infrared, etc. One or more of the remote devices illustrated in FIG. 3 may be operatively coupled with computing devices 100 by communication links 116A-116D. In some examples, communication links 112A-112D may be connections using Bluetooth, Near-Field Communication, Universal Serial Bus, infrared, etc. Such connections may be wireless and/or wired connections.

In accordance with techniques of the disclosure, computing devices 100 may be operatively coupled to visual display device 130 using external network 114. Responsive to outputting a search query associated with computing devices 100 to an information server system such as ISS 20 of FIGS. 1 and 2, computing devices 100 may receive, from the information server system such as ISS 20 of FIGS. 1 and 2, an indication (e.g., data) of renderable content based on information returned from a search of the search query. The renderable content may be tailored specifically for the device type associated with computing devices 100 and may include information that is more likely to be of the kind of information that the user was intending to search.

Responsive to receiving the indication of the renderable content, computing devices 100 may output a graphical indication (e.g., a graphical user interface, an interactive graphical element, etc.) as a rendering of the renderable content. For examples, computing devices 100 may render the renderable content and output, for display, the rendered content to visual display device 130. Computing devices 100 may output, for display, the rendered content via direct device communication 118 or external network 114 to display device 130. In some examples, display device 130 outputs the rendered content for display to the user associated with computing devices 100 and the user may, in turn, interact with computing devices 100 by selecting or dismissing some or all of the displayed rendered content.

FIGS. 4A-4D are conceptual diagrams illustrating example graphical user interfaces presented by example computing devices that are configured to receive renderable content based on information that is returned from a search of a modified search query, in accordance with one or more aspects of the present disclosure. FIGS. 4A-4D are described below in the context of computing devices 10 of FIG. 1. For example, FIG. 4A shows user interface 202A being presented by UID 12A at mobile device 10A and FIGS. 4B-4D shows user interfaces 202B-202D being presented by UID 12N at wearable device 10N.

With reference to FIGS. 4A, ISS 20 may receive a search query from mobile device 10A at a particular time of day, when mobile device 10A is at a physical location. For example, ISS 20 may receive a search query that indicates the name of a national coffee chain (e.g., as text or audio date) but may not include any other information about the type of information that the user of mobile device 10A is searching for at the current time while at the current location. At the time the query is received, ISS 20 may receive information from mobile device 10A indicating the device type of mobile device 10A.

To improve the search experience the user has when using mobile device 10A, ISS 20 may infer user intention in the search query, based on the device type. For instance, intention module 24 may input the device type and query into a machine learning algorithm or other rules based algorithm and determine that since the query comes from a “mobile device” rather than a “wearable device” that the user is likely searching for general information about the national chain of coffee houses and/or a list of nearby locations.

Query module 22 of ISS 20 may append the term “near current location” to the search query to focus a search of the search query to identify nearby coffee houses that satisfy the user intention. Query module 22 may receive the term “near current location” from data store 36A after inputting an indication of the inferred intention.

In any event, presentation module 26 may receive information returned from a search executed (e.g., by SSS 60) on the modified search query of the national chain of coffee houses near the current location and generate renderable content based on the information returned from the search for presentation at mobile device 10A.

In the example of FIG. 4A, responsive to determining the search query is a location (e.g., nation chain of coffee houses) and the device type is a non-wearable, mobile computing device, ISS module 20A may rank the one or more search results according to nearest distance from, or shortest time to arrive at, the location. For example, taking into account the user intention in conducting the search of the search query, ISS 20 may not only modify the search query based on user intention, but ISS 20 may also rank the search results differently depending on the type of device.

Presentation module 26 may output the renderable content via network 30B to mobile device 10A. Mobile device 10A may render the renderable content and cause UID 12A to output the information contained within the renderable content for display as user interface 202A. For example, FIG. 4A shows the search results ranked in order from nearest to furthest coffee house, from the current location of mobile device 10A.

Juxtaposed to FIG. 4A, FIG. 4B illustrates an example where ISS 20 may receive the same search query from wearable device 10N at the same particular time of day, and from the same physical location, as mobile device 10A of FIG. 4A. For example, ISS 20 may receive the same search query that indicates the name of a national coffee chain (e.g., as text or audio date) but may not include any other information about the type of information that the user of wearable device 10N is searching for at the current time while at the current location. At the time the query is received, ISS 20 may receive information from wearable device 10N indicating the device type of mobile device 10N.

Again, to improve the search experience the user has when using wearable device 10N, ISS 20 may infer user intention in the search query, based on the device type. For instance, intention module 24 may input the device type and query into a machine learning algorithm or other rules based algorithm and determine that since the query comes from a “wearable device” rather than a “mobile device” or rather than a “non-wearable device” that the user is likely searching for specific information (e.g., time data, distance data, fitness data, etc.) about the national chain of coffee houses (such as hours of operation) of a nearby location.

Query module 22 of ISS 20 may append the term “hours of operation” to the search query to focus a search of the search query to identify the hours of operation of nearby coffee houses that satisfy the user intention. Query module 22 may receive the term “hours of operation” from data store 36A after inputting an indication of the inferred intention received from intention module 24.

Continuing with the example of FIG. 4B, presentation module 26 may receive information returned from a search executed (e.g., by SSS 60) on the modified search query of the hours of operation of the national chain of coffee houses and generate renderable content based on the information returned from the search for presentation at mobile device 10A.

Presentation module 26 may output the renderable content via network 30B to wearable device 10N. Wearable device 10N may render the renderable content and cause UID 12N to output the information contained within the renderable content for display as user interface 202B. For example, FIG. 4B shows the renderable content as comprising instructions for causing, when rendered, UID 12N to present the hours of operation of the national coffee house as being two hour hands that bound an opening time and a closing time associated with the location. Presentation module 26 may extract the hours of operation and a graphical logo associated with the national coffee house chain from a highest ranking webpage search result. Then, as a function of the device type, presentation module 26 formats the hours of operation, graphical logo, and other information extracted from the highest ranking webpage in a way that the information will be more useful in satisfying the user's intention. For example, rather than simply present the hours of operation as text, the hours are presented as clock hands that are more suited for display at a watch.

FIGS. 4C and 4D show additional example user interfaces 202C and 202D presented by wearable device 10N after receiving renderable content based on information returned from a search executed by ISS 20 and SSS 60. In the examples of FIGS. 4C and 4D, the renderable content received by wearable device 10N from ISS 20 includes instructions for presenting an animated and interactive graphical element tailored for use at wearable device 10N. Both user interfaces 202C and 202D include a step tracker that counts down a distance to a location of one of the national chain of coffee houses. In some examples, the step tracker may be replaced by, or also include, a timer that counts down an amount of time remaining until a final time to reach the location of the coffee house from the current location. In some examples, the timer may indicate a target time for the user to make the walk to the location (e.g., like a stop watch). In other words ISS 20 returns a search result as an actual interactive experience that is appropriate for wearable device 10N to meet a fitness goal. ISS 20 creates a user interface for content extracted from search result pages that is more appropriate for the type of device the user interface is being presented at. In some examples, the renderable content returned by ISS 20 may include additional instructions that cause UID 12N to present a “standard search results”; such as text from a webpage in response to detecting user input (e.g., tapping the watch face). Examples of further instructions include instructions for invoking applications or specific features of the device in addition to presenting the renderable content. For instance, if the renderable content is fitness related, the further instructions may invoke a fitness tracking application to display data (e.g., steps) associated with the search results.

In some examples, presentation module 26 may rank, based at least in part on the device type, one or more search results returned from the search, and then generate, based on the highest ranking search result from the one or more search results, the renderable content. For example, rather than always automatically rank the nearest coffee house to the current location as being the highest ranking search result as shown in FIG. 4A, presentation module 26 may rank the second or third closest coffee houses as the highest ranking search result when the search query for the national chain of coffee houses is received from wearable device 10N. That is, prediction module 26 may modify the ranking of search results based on device type and/or user intention. Prediction module 26 may cause the highest ranking search result for one intention may be different than the highest ranking search result for a different intention. Prediction module 26 may cause the highest ranking search result for a wearable device to be different than the highest ranking search result for non-wearable device.

For example, prediction module 26 may rank a location that is further away based on an inference that the user intention is to find information to achieve a fitness goal or that the user is likely to be interested in fitness. In some examples, ISS 20 and prediction module 26 have access to user information (e.g., a profile) that includes fitness goals of the user and may rank a location that is further or nearer than a current location so as to assist the user in achieving his or her fitness goal. If the fitness goal is to walk more, prediction module 26 may rank further locations higher, and if the fitness goal is to walk less or walk no more than a certain amount, prediction module 26 may assign nearer locations with a higher ranking

In some examples, responsive to determining the search query is a location (e.g., a national chain of coffee houses or other establishment) and the device type is a wearable device, ISS 20 may rank the one or more search results with a highest ranking result being more likely to assist a user in achieving a fitness goal.

For example, ISS 20 may return a ranked list of locations of the national chain of coffee houses ordered by distance and annotated with customized distance information tied to the individual user's fitness goals. The fitness goals may be passed to ISS 20 as part of the query or may be maintained at ISS 20 as a profile or state for the user (e.g., in the cloud). For example, if a user has a fitness goal of walking 10,000 steps per day and if the user has walked 9000 steps at the time of query, ISS 20 may rank as the highest result the national coffee house which is approximately 1000 steps away, rather than the closer locations that are 400 steps or less away so as to make it more likely that the user will achieve the 10,000 step fitness goal. In some examples, ISS 20 may further include information from a recommendation service access by ISS 20 that includes recommendations for products at the location that is aided in achieving the fitness goal (e.g., a recommendation of a drink at the coffee house that is within the user's caloric inputs for the day).

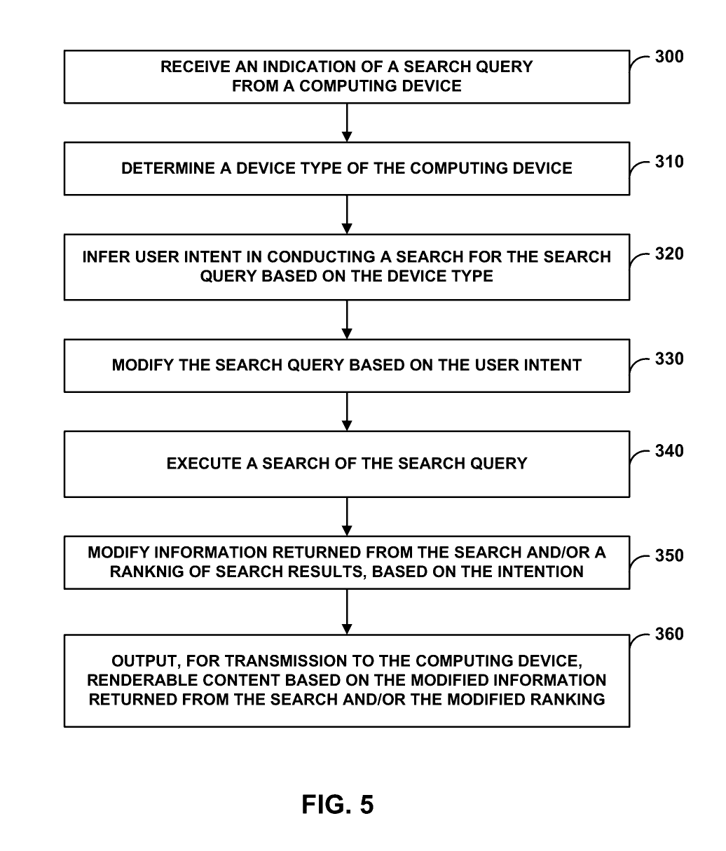

FIG. 5 is a flowchart illustrating example operations performed by an example computing system configured to modify a search query and output renderable content based on information returned from a search of the modified search query, in accordance with one or more aspects of the present disclosure. Operations 300-360 of FIG. 5 are described below within the context of system 1 of FIG. 1 and ISS 20 of FIG. 2. For example, modules 22-28 of ISS 20 may be operable by at least one of processors 70 of ISS 20 to perform operations 300-360 of FIG. 5.

In operation, ISS 20 may receive an indication of a search query from a computing device (300). For example, query module 22, while operable by one or more processors 70, may receive information from computing device 10N that includes a request for ISS 20 to conduct a search of a search query. The search query may be, for example, a location, business, or other commercial, governmental, or non-commercial and non-governmental establishment. In order to provide an improved search experience, including information from the search that is more likely to be relevant to the intention of the user of wearable device 10N in conducting the search, query module 22 may call on intention module 24 to determine an intention of the user of wearable device 10N in conducting the search.

ISS 20 may associate a device type with the computing device (310). For example, intention module 24, after being called on by query module 22, may infer (e.g., from contextual information, metadata received from wearable device 10N, or other types of identifiable information) a device type associated with wearable device 10N. Intention module 24 may determine based on a device identifier received by ISS 20 from wearable device 10N that wearable device 10N has a device type that corresponds to a wearable device.

ISS 20 may infer user intention in conducting a search for the search query based on the device type (320). For example, intention module 24 may provide the device type of wearable device 10N as well as the search query (e.g., a textual term) to the machine learning algorithm of data store 36B and receive, as output from data store 36B, an indication of the user intention. Intention module 24 may share the user intention with query module 22.

ISS 20 may modify the search query based on the user intention (330). For example, query module 22 may rely on data store 36A to provide one or more additional search terms or one or more additional search parameters, that query module 22 can add to the search query received from wearable device 10N to increase a likelihood that the information returned from a search of the search query will produce information that the user is searching for. Query module 22 may receive the one or more additional search terms or parameters from data store 36A and append the additional terms or parameters to the search query before conducting the search.

ISS 20 may include all or some of the features of SSS 60 for conducting a search. For instance, ISS 20 may include search module 62. In the even that ISS 20 includes search module 62, ISS 20 may execute a search of the search query (340) after modification. For example, search module 62 may a text string, audio data, or other information from query module 22 that is indicative of the modified search query including one or more words, sounds, or graphics to be searched. Search module 62 may conduct an Internet search based on the search query to identify one or more data files, webpages, or other types of data accessible on the Internet that include information related to the search query. After executing a search, search module 62 may produce information returned from the search (e.g., a list of one or more uniform resource locators [URLs], or other addresses identifying the location of a file on the Internet that consists of the protocol, the computer on which the file is located, and the file's location on that computer). In some examples, search module 62 may produce a ranking of the different types of information returned from the search so as to identify which pieces of information are more closely related to the search query. Search module 62 may output the information returned from a search and/or a ranking back to query module 22.

ISS 20 may modify information returned from the search and/or a ranking of search results, based on the intention (350). For instance, rather than modify the search query, or in addition to modifying the search query, prediction module 26 may rank, based at least in part on the device type, one or more search results returned from the search. That is, if the search is performed from a non-wearable device, prediction module 26 may rank different search results higher than if the search is performed from a wearable device. Prediction module 26 may modify the information returned from the search by at least extracting data from a webpage associated with the highest ranking search result from the one or more search results, and format the extracted data as the renderable content.

ISS 20 may extract content from search result resources, and package the content into a form of renderable content for presentation by wearable device 10N also as a function of intention. For example, presentation module 26 may generate data that includes instructions for configuring wearable device 10N and UID 12N to present an animated and interactive graphical element (e.g., a timer, a step counter, and the like) based on the information returned from the search. Likewise, presentation module 26 may generate data that includes instructions for configuring wearable device 10N and UID 12N to present a static graphical image (e.g., a webpage, a list of hyperlinks, text of a webpage, and the like) of information returned from the search. Presentation module 26 may determine that the animated and interactive graphical element is more appropriate for presentation at wearable device 10N in response to determining the type of device is a wearable device. Said differently, presentation module 26 may generate renderable content as code for rendering a device specific user interface, other than that specified by the search result page's HTML code, for display of selected portions of the content from one or more of the search results pages.

Presentation module 26 may determine that the static graphical image is more appropriate for presentation at non-wearable devices, such as mobile device 10A in response to determining the type of device is a mobile device or a non-wearable mobile computing device. Said differently, presentation module 26 may generate renderable content as the HTML code for rendering the search results page or webpage associated with the highest ranking search results in response to determining the type of device is a non-wearable device.

ISS 20 may output, for transmission to the computing device, renderable content based on information returned from the search (360). For example, presentation module 26 may provide the renderable content to query module 22 and query module 22 may output the renderable content generated by presentation module 26 for transmission back to wearable device 10N, to fulfill the search request.

In this way, ISS 20 provides renderable content for presentation by devices 10 depending upon the search query (e.g., the location, the business/establishment) and the type of device from which the query originates and/or the type of device at which the search results are destined (e.g., the endpoint device). ISS 20 may change the ranking of search results based on a likely user intention in conducting a search of the search query (e.g., ISS 20 may infer that a user querying from a watch about a business indicates that the user cares about the hours the business is open). Based on the inferred user intention, ISS 20 may generate renderable content for presentation as a search result that is “oriented” specifically around the “hours of operation” of the business. Additionally, the renderable content may be personalized according to the user. In other words two different users on the same kind or type of device, conducting a search from the same location, may receive from ISS 20, different results to their respective query because they have different inferred intentions, fitness targets, or other personalized preferences.

Clause 1. A method comprising: receiving, by a computing system, from a computing device, an indication of a search query; associating, by the computing system, a device type with the computing device; inferring, by the computing system, based at least in part on the device type, user intention in conducting a search of the search query; modifying, by the computing system, based on the user intention, the search query; after modifying the search query, executing, by the computing system, a search of the search query; and outputting, by the computing system, for transmission to the computing device, renderable content based on information returned from the search.

Clause 2. The method of clause 1, wherein a first intention in conducting a search of the search query is inferred for a first device type and a second intention in conducting a search of the search query, different from the first intention, is inferred for a second device type that is different from the first device type.

Clause 3. The method of clause 2, wherein the first device type is a wearable computing device and the second device type is a non-wearable, mobile computing device.

Clause 4. The method of clause 3, wherein the first intention in conducting a search of the search query is related to a time, a distance, or a purchase price associated with the search query and the second intention in conducting a search of the search query is related to contact information, review information, or other information not related to a time, a distance, or a purchase price associated with the search query.

Clause 5. The method of any of clauses 1-4, wherein modifying the search query comprises: determining, by the computing system, one or more additional search parameters for focusing the search towards a specific result that is based on the user intention; and adding, by the computing system, the one or more additional search parameters to the search query.

Clause 6. The method of any of clauses 1-5, further comprising: determining, by the computing system, based at least in part on the device type, a feature of the computing device, wherein the search query is further modified, before execution of the search, based on the feature of the computing device.

Clause 7. The method of clause 6, wherein the device type is a wearable device type and the primary feature is at least one of fitness tracking, tracking a time of day, or tracking distance traveled.

Clause 8. The method of any of clauses 6-7, wherein further modifying the search query based on the feature of the computing device comprises at least one of: adding a current location of the computing device to the search query; adding a time parameter to the search query; or adding a distance parameter to the search query.

Clause 9. A computing system comprising: at least one processor; and at least one module operable by the at least one processor to: receive, from a computing device, an indication of a search query; associate a device type with the computing device; infer, based at least in part on the device type, user intention in conducting a search of the search query; modify, based on the user intention, the search query; after modifying the search query, execute, a search of the search query; and output, for transmission to the computing device, renderable content based on information returned from the search.

Clause 10. The computing system of clause 9, wherein the at least one module is further operable by the at least one processor to, prior to outputting the renderable content based on the information returned from the search of the search query: determine, based on the user intention, a portion of the information returned from the search that satisfies the user intention; and generate, based on the portion of the information, the renderable content.

Clause 11. The computing system of any of clauses 9-10, wherein the at least one module is further operable by the at least one processor to generate the renderable content based on the user intention and the device type of the computing device.

Clause 12. The computing system of clause 11, wherein the at least one module is further operable by the at least one processor to generate first renderable content based on the user intention if the device type of the computing device is a wearable device type and generate second renderable content based on the user intention that is different from the first renderable content, if the device type of the computing device is not a wearable device type.

Clause 13. The computing system of clause 12, wherein the first renderable content comprises instructions for presenting an animated and interactive graphical element based on the information returned from the search and the second renderable content comprises instructions for presenting a static graphical image of information returned from the search.

Clause 14. The computing system of clause 13, wherein the animated and interactive graphical element comprises a step tracker that counts down a distance to a location or a timer that counts down an amount of time remaining until a final time associated with the location.

Clause 15. The computing system of any of clauses 11-14, wherein the wearable device type is a watch, and the first renderable content comprises instructions for presenting two hour hands that bound an opening time and a closing time associated with a location.

Clause 16. A computer-readable storage medium comprising instructions that, when executed configure one or more processors of a computing system to: receive, from a computing device, an indication of a search query; associate a device type with the computing device; infer, based at least in part on the device type, user intention in conducting a search of the search query; execute a search of the search query; modify, based on the user intention, information returned from the search; and after modifying the information returned from the search, output, for transmission to the computing device, renderable content based on the modified information returned from the search.

Clause 17. The computer-readable storage medium of clause 16 comprising further instructions that, when executed configure the one or more processors of the computing system to: rank, based at least in part on the device type, one or more search results returned from the search, wherein modifying the information returned from the search comprises extracting data from a webpage associated with the highest ranking search result from the one or more search results; and formatting the extracted data as the renderable content.

Clause 18. The computer-readable storage medium of clause 17 comprising further instructions that, when executed configure the one or more processors of the computing system to: responsive to determining the search query is a location and the device type is a non-wearable, mobile computing device, rank the one or more search results according to nearest distance from, or shortest time to arrive at, the location; and responsive to determining the search query is the location and the device type is a wearable device, rank the one or more search results with a highest ranking result being more likely to assist a user in achieving a fitness goal.

Clause 19. The computer-readable storage medium of any of clauses 16-18, wherein a first intention in conducting a search of the search query is inferred for a first device type and a second intention in conducting a search of the search query, different from the first intention, is inferred for a second device type that is different from the first device type.

Clause 20. The computer-readable storage medium of any of clauses 16-19, wherein the first device type is a wearable computing device and the second device type is a non-wearable, mobile computing device.

Clause 21. The computing system of clause 9, comprising means for performing any of the methods of clauses 1-8.

Clause 21. The computer-readable storage medium of clause 16, comprising further instructions that, when executed configure the one or more processors of the computing system to perform any of the methods of clauses 1-8.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable medium may include computer-readable storage media or mediums, which corresponds to a tangible medium such as data storage media, or communication media including any medium that facilitates transfer of a computer program from one place to another, e.g., according to a communication protocol. In this manner, computer-readable medium generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

What is claimed is:

1. A method comprising:
receiving, by a computing system, from a computing device, an indication of a search query;
associating, by the computing system, a device type with the computing device;
inferring, by the computing system, based at least in part on the device type, user intention in conducting a search of the search query;
modifying, by the computing system, based on the user intention, the search query;
after modifying the search query, executing, by the computing system, a search of the search query; and
outputting, by the computing system, for transmission to the computing device, renderable content based on information returned from the search.

2. The method of claim 1, wherein a first intention in conducting a search of the search query is inferred for a first device type and a second intention in conducting a search of the search query, different from the first intention, is inferred for a second device type that is different from the first device type.

3. The method of claim 2, wherein the first device type is a wearable computing device and the second device type is a non-wearable, mobile computing device.

4. The method of claim 3, wherein the first intention in conducting a search of the search query is related to a time, a distance, or a purchase price associated with the search query and the second intention in conducting a search of the search query is related to contact information, review information, or other information not related to a time, a distance, or a purchase price associated with the search query.

5. The method of claim 1, wherein modifying the search query comprises:
determining, by the computing system, one or more additional search parameters for focusing the search towards a specific result that is based on the user intention; and
adding, by the computing system, the one or more additional search parameters to the search query.

6. The method of claim 1, further comprising:
determining, by the computing system, based at least in part on the device type, a feature of the computing device, wherein the search query is further modified, before execution of the search, based on the feature of the computing device.

7. The method of claim 6, wherein the device type is a wearable device type and the primary feature is at least one of fitness tracking, tracking a time of day, or tracking distance traveled.

8. The method of claim 6, wherein further modifying the search query based on the feature of the computing device comprises at least one of:
adding a current location of the computing device to the search query;
adding a time parameter to the search query; or
adding a distance parameter to the search query.

9. A computing system comprising:
at least one processor; and
at least one module operable by the at least one processor to:
receive, from a computing device, an indication of a search query;
associate a device type with the computing device;
infer, based at least in part on the device type, user intention in conducting a search of the search query;
modify, based on the user intention, the search query;
after modifying the search query, execute, a search of the search query; and
output, for transmission to the computing device, renderable content based on information returned from the search.

10. The computing system of claim 9, wherein the at least one module is further operable by the at least one processor to, prior to outputting the renderable content based on the information returned from the search of the search query:
determine, based on the user intention, a portion of the information returned from the search that satisfies the user intention; and
generate, based on the portion of the information, the renderable content.

11. The computing system of claim 9, wherein the at least one module is further operable by the at least one processor to generate the renderable content based on the user intention and the device type of the computing device.

12. The computing system of claim 11, wherein the at least one module is further operable by the at least one processor to generate first renderable content based on the user intention if the device type of the computing device is a wearable device type and generate second renderable content based on the user intention that is different from the first renderable content, if the device type of the computing device is not a wearable device type.

13. The computing system of claim 12, wherein the first renderable content comprises instructions for presenting an animated and interactive graphical element based on the information returned from the search and the second renderable content comprises instructions for presenting a static graphical image of information returned from the search.

14. The computing system of claim 13, wherein the animated and interactive graphical element comprises a step tracker that counts down a distance to a location or a timer that counts down an amount of time remaining until a final time associated with the location.

15. The computing system of claim 11, wherein the wearable device type is a watch, and the first renderable content comprises instructions for presenting two hour hands that bound an opening time and a closing time associated with a location.

16. A computer-readable storage medium comprising instructions that, when executed configure one or more processors of a computing system to:
receive, from a computing device, an indication of a search query;
associate a device type with the computing device;
infer, based at least in part on the device type, user intention in conducting a search of the search query;
execute a search of the search query;
modify, based on the user intention, information returned from the search; and
after modifying the information returned from the search, output, for transmission to the computing device, renderable content based on the modified information returned from the search.

17. The computer-readable storage medium of claim 16 comprising further instructions that, when executed configure the one or more processors of the computing system to:
rank, based at least in part on the device type, one or more search results returned from the search, wherein modifying the information returned from the search comprises extracting data from a webpage associated with the highest ranking search result from the one or more search results; and formatting the extracted data as the renderable content.

18. The computer-readable storage medium of claim 17 comprising further instructions that, when executed configure the one or more processors of the computing system to:
responsive to determining the search query is a location and the device type is a non-wearable, mobile computing device, rank the one or more search results according to nearest distance from, or shortest time to arrive at, the location; and
responsive to determining the search query is the location and the device type is a wearable device, rank the one or more search results with a highest ranking result being more likely to assist a user in achieving a fitness goal.

19. The computer-readable storage medium of claim 16, wherein a first intention in conducting a search of the search query is inferred for a first device type and a second intention in conducting a search of the search query, different from the first intention, is inferred for a second device type that is different from the first device type.

20. The computer-readable storage medium of claim 16, wherein the first device type is a wearable computing device and the second device type is a non-wearable, mobile computing device.
